(19) United States
(12) Patent Application Publication
(10) Pub. No.: US 2006/0018476 A1
(43) Pub. Date: Jan. 26, 2006

(54) Key path generation and exchange of cryptographic keys using path length noise

(76) Inventor: George H. Nickel, Evergreen, CO (US)

Correspondence Address: UNIVERSITY OF CALIFORNIA;LOS ALAMOS NATIONAL LABORATORY, P.O. BOX 1663, MS A187, LOS ALAMOS, NM, 87545, US

(21) Appl. No.: 10/874,483

(22) Filed: Jun. 23, 2004

(51) Int. Cl. H04K 1/00

(52) U.S. Cl. 380/256

(57) ABSTRACT

Apparatus for sending cryptographic key information through a turbulent medium features a radiation generator in a first enclosure for emitting radiation at a predetermined wavelength through first launching means for launching the radiation into turbulent media. A second launching means in a second enclosure is located a distance from the first enclosure for receiving the radiation launched from the first launching means after the radiation has traversed the turbulent media, and focusing the radiation onto detection means for determining a unique cryptographic key.

The present invention generally relates to secure cryptographic key exchange, and, more specifically to use of natural ambient turbulence to generate and share cryptographic keys. This invention was made with Government support under Contract No. W-7405-ENG-36 awarded by the U.S. Department of Energy. The Government has certain rights in the invention.

### BACKGROUND OF THE INVENTION

Since perhaps the earliest use of smoke or mirrors for signaling, man has sought a truly secure method of exchanging information without third parties being privy to what information is being exchanged. Over the years many cryptographic schemes have been developed, from relatively simple alpha-numeric conversions to elaborate scrambling techniques. However, most systems devised have been subject to interception and subsequent deciphering. This was illustrated importantly by the ease with which the Allies, in World War II, broke the Japanese codes, which they intercepted, and thereby used the information obtained to seriously damage the Japanese war effort.

One popular method for secure communications involves key-based cryptography, where a “key” is a sequence of random binary numbers. Key-based cryptography is a method in which a particular tool for decoding a message, the key, is relayed to the authorized recipient to allow the encoded message to be decoded. In this method, the key is used to enable the encryption and decryption of a message in such a way that an eavesdropper who has intercepted the message has no way to decipher the message without knowing the key. It is obvious with this cryptographic system that security of the key itself is of paramount importance.

Recently, quantum cryptography, a process in which single photons are sent between two positions to establish a secure key based on fundamental uncertainty relations, has been developed. While very effective, it currently is uncertain how far apart the two positions can be and still have effective communication. Also, the quantum cryptography systems are very complicated, since single photon creation and detection are not simple matters.

Therefore, a need exists for an equally secure system that is not as complicated and expensive as quantum cryptography. The present invention discloses such a system that uses the natural turbulence and noise between the two positions to create a virtually unbreakable key.

### SUMMARY OF THE INVENTION

In order to achieve the objects and purposes of the present invention, and in accordance with its objectives, apparatus for sending cryptographic key information through a turbulent medium comprises a radiation generator in a first enclosure for emitting radiation at a predetermined wavelength through first launching means for launching the radiation into turbulent media. A second launching means in a second enclosure located a distance from the first enclosure for receives the radiation launched from the first launching means after the radiation has traversed the turbulent media, and focusing the radiation onto detection means for determining a unique cryptographic key.

### BRIEF DESCRIPTION OF THE DRAWINGS

The accompanying drawings, which are incorporated in and form a part of the specification, illustrate an embodiment of the present invention and, together with the description, serve to explain the principles of the invention. In the drawings:

FIG. 1 is a schematic illustration of transceivers utilizing lasers according to the present invention to be used in an optical communication arrangement.

FIG. 2A is a plot of signal waveforms received at each optical transceiver in a field test, and FIG. 2B is a plot of auto and cross correlations versus time for the same test.

FIG. 3 is a schematic illustration another embodiments of transceivers utilizing RF transmitters according to the present invention to be used in a RF communication arrangement.

### DETAILED DESCRIPTION

The present invention provides secure communication in free space. It utilizes the natural ambient turbulence to create secure keys for use in cryptographic communication. The invention can be most easily understood through reference to the drawings.

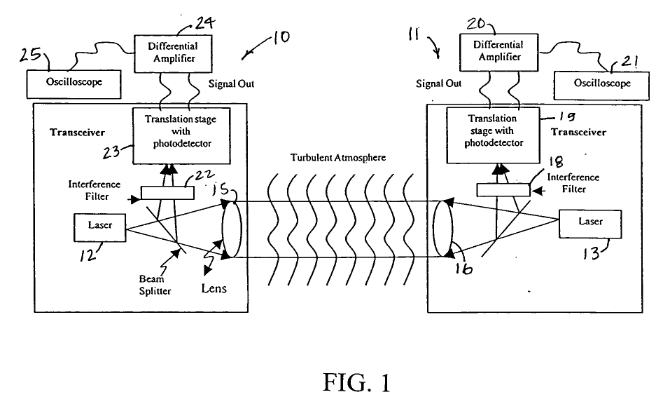

Referring first to FIG. 1, there can be seen a schematic drawing of one embodiment of the present invention. As seen identical transceivers 10, 11 each has a transceiver 10, 11, which have lasers 12, 13, respectively, associated with it. Lasers 12, 13 can be battery powered diode lasers or light emitting diodes. Each laser 12, 13 operates at a slightly different wavelength. For example, laser 12 could operate at 651 nm and laser 13 could operate at 676 nm so that each transceiver 10, 11 will be sensitive only to light from the other laser.

Laser 12 emits its light output through beam splitter 14, where half of the light output is dumped to one side and the other half is focused into a parallel beam by lens 15 and launched. Lens 15 can be a commercially available f/8, 500 mm focal length, catadioptical lens. Light received at the other transceiver 11 is collected by lens 16 and directed to beam splitter 17 where half of the light is discarded and the other half is directed to narrowband interference filter 18. Interference filter 18 admits only the wavelength of light emitted by transceiver 10 for passage to translation stage with photodetector 19. Translation stage with photodetector 19 is a photodiode array mounted on a xyz micrometer translation stage, which is used to position light incoming from interference filter 18 at a point at the boundary of photodiode segments of the photodiode array.

The signal output 19a of translation stage with photodetector 19 is provided to differential amplifier 20 where it is processed and provided to oscilloscope 21, or to any appropriate output device. Oscilloscope 21 allows an operator to observe the cryptographic key sent by transceiver 10.

The same process occurs when transceiver 11 sends a key to transceiver 10. In this case, laser 13 emits light that is collected and focused by lens 16 and is sent through the turbulent media to transceiver 10 where it is received and focused by lens 15 to beam splitter 14 and directed to interference filter 23. The light from transceiver 11 is then passed to translation stage with photodetector 23, where as with translation stage with photodetector 19, the light is positioned at the boundary of photodiode segments of the photodiode array.

The signal output 23a of translation stage with photodetector 23 is provided to differential amplifier 24, where if is processed and provided to oscilloscope 25, or to any other appropriate output device. As with transceiver 11, oscilloscope 25 allows an operator to observe the cryptographic key sent by transceiver 11.

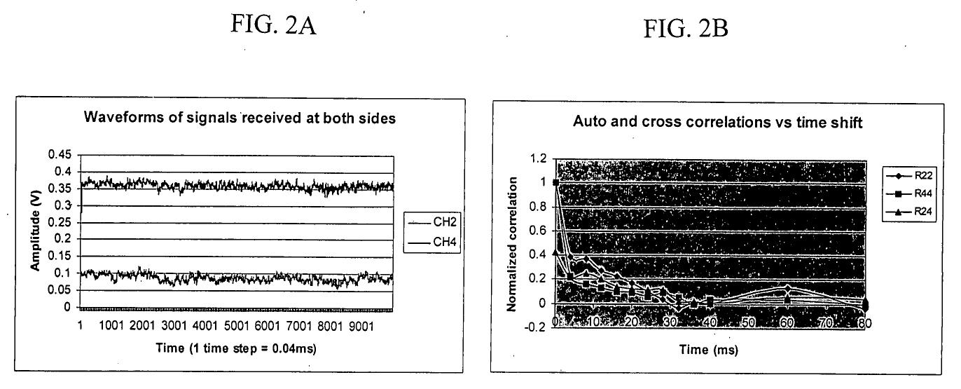

Referring now to FIG. 2A, where the waveforms received by each transceiver 10, 11 in a test of this embodiment of the present invention is shown. In this outdoor test, transceivers 10, 11 were separated by 100 m at a time when the wind speed was 4.3 m/s, the temperature was 21.8° C., the humidity was 16%, and the solar radiation was 313 W/m². The period of transmission was 400 ms. Use of the waveforms to develop a unique cryptographic key is straightforward, particularly to those with skill in this art. Initially, appropriate care is employed to determine the mean of the sampled waveforms, and remove the dc component. It has been determined that sampling the waveform at approximately 10 ms intervals aids in avoiding cross-correlation problems. FIG. 2B illustrates the plot of auto and cross correlations versus time shift for this same test.

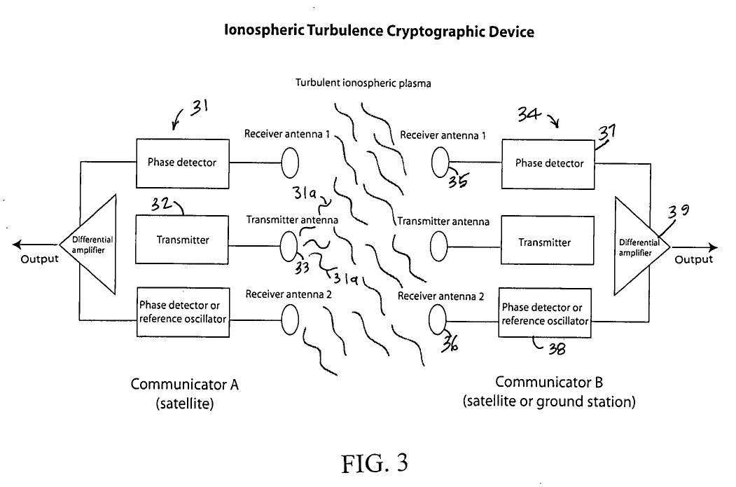

Another embodiment of the present invention is illustrated in FIG. 3. Here, the source of radiation emits a radio-frequency (RF) signal. As seen, transmitter 32 in transceiver 31 emits a signal 31a, preferably at a frequency in the range of megahertz, through antenna 33 toward transceiver 34. At transceiver 34, antenna 35 and/or antenna 36 receive signal 31a after it has traversed a distance through ionospheric turbulence. The reason that antenna 36 may or may not receive signal 31a is that there exist two primary detection means for this embodiment. The first is to compare the phase of signal 31a with a reference signal provided by a local oscillator or other external reference at the site of transceiver 33. In this case, there is no need for antenna 36 to be in use. The second means utilizes two separate propagation paths, and the difference in phases between the two paths received by both antennas 35, 36 is used as the random signal.

As shown, antenna 35 is connected to phase detector 37 whose output is provided to differential amplifier 38. Antenna 36 is connected to phase detector or reference oscillator 38 whose output also is connected to differential amplifier 39. It is interesting with this embodiment of the present invention that the transmissions, in addition to earthbound operation, can be used in earth to satellite transmissions, and in satellite-to-satellite transmissions.

Those with skill in this art will understand that when electromagnetic radiation propagates through a random medium, such as the atmosphere, the surface of uniform phase, called the wavefronts, are distorted. A random medium is a medium whose properties, such as the number density, vary in space and time from their average values by amounts that cannot be described by any prior information, but only by their statistical distributions. For statistical distributions created by turbulence, it is generally observed that the spatial variations are described by a specific mathematical distribution, known as “gaussian,” and that the temporal variations are correlated only for observations within a finite time interval. Data sampled for longer time intervals are uncorrelated, and represent independent measurements. Although it is usually assumed that the wavefronts are initially uniformly spaced parallel planes, it is also possible to create wavefronts that have initial variations in time that are only known to the operators to transceivers 10, 11 or 31, 34.

This initial variation can provide an additional layer of security for this invention. If both operators already have shared key material, a sequence of encrypted initial phase tilts could be incorporated into both transceivers 10, 11 or 31, 34. The initial tilts do not have to be the same for each transceiver 10, 11 or 31, 34 as long as each operator knows the initial tilt used by the other operator. As the phase tilted light propagates through the turbulent media, it is further perturbed by the random propagation path. Therefore the received bit string is the logical product of the initial tilted string and the random string that is produced by the propagation path. In this situation, an eavesdropper who may know the received tilt string at one end, would have no way of inferring the actual key string produced by the propagation path.

In the propagation path, time delays, tilts and/or curvatures of the wavefronts are induced by the variations of the speed of the wavefronts in the medium. These variations are described by the index of refraction, the factor by which the speed in a vacuum is reduced due to the effect of the medium. When the index of refraction of a medium differs only slightly from one, which is the case in a gaseous medium of sufficiently low density, its value differs from one by an amount proportional to the number of particles per unit volume (air molecules for optical transmission, or electrons for ionospheric plasmas) multiplied by a quantity called the polarizability. This quantity is a characteristic of the medium whose dimensions are those of volume. The propagation of optical signals in the atmosphere or radio waves in the ionosphere differ only by the values of their particle density and ploarizability, and the statistical parameters of their random spatial and temporal random variations.

Although the propagation of optical signals in the atmosphere, or radio waves in the ionosphere obey the same statistical distributions and similar physical mechanisms, the manner in which the variations are detected are detected at the receiving transceiver 10, 11 or 31, 34 is different.

In the case of optical signals, it is known that optical wavelengths generally are small compared to the diameter of the receiving transceiver 10, 11, which allow the detection of tilt in the phase wavefronts. An optical system represents a transformation from the direction of the input signal to a position in the focal plane of the receiving transceiver 10, 11. An optical signal whose phase wavefronts have been tilted mimic a signal arriving from a different direction. Variations in the position of a focal spot can be measured by the difference in the signals from two closely spaced electronic radiation detectors, such as the silicon photodiodes of translation stage with photodetectors 19, 23. Curvatures of the wavefronts create focal spots in front of or behind the focal plane, and can be ignored for receiving apertures smaller than a known value, determined by the properties of the random medium. In any event, the lateral changes in position are measurable.

Alternatively, radio signals have wavelengths that are now small large compared to the receiving transceivers 31, 34 apertures. Instead of spatial variation caused by wavefront tilts, the random phase errors created by propagation variations are used. This requires a time reference for detection, which can be provided by a stable local signal reference, or by a separate signal received by both transceivers 31, 34. Actually, optical phase errors can be detected easily in optical systems. To accomplish this requires only an interferometer and a coherent reference optical beam. The waveforms obtained in this embodiment are used, as described above, to obtain a random cryptographic key.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. Apparatus for sending cryptographic key information through a turbulent medium comprising:
a radiation generator in a first enclosure for emitting radiation at a predetermined wavelength through first launching means for launching said radiation into turbulent media;
a second launching means in a second enclosure located a distance from said first enclosure for receiving said radiation launched from said first launching means after said radiation has traversed said turbulent media, and focusing said radiation onto detection means for determining a unique cryptographic key.

2. The apparatus as described in claim 1 wherein said radiation generator is a laser.

3. The apparatus as described in claim 2 wherein said first and second launching means are lens.

4. The apparatus as described in claim 1 wherein said radiation generator is a RF generator.

5. The apparatus as described in claim 4, wherein said first and second launching means are antennae.

6. Apparatus for sending cryptographic key information through a turbulent medium comprising:
a laser located in a first enclosure for emitting light at a predetermined wavelength through first lens means for launching said light into turbulent media;
a second lens means in a second enclosure located a distance from said first enclosure for receiving said light launched from said first lens means after said light has traversed said turbulent media, and focusing said light onto detection means for determining a unique cryptographic key.

7. Apparatus for sending cryptographic key information through a turbulent medium comprising:
a RF generator in a first enclosure for emitting RF radiation at a predetermined wavelength through first antenna means for launching said RF radiation into turbulent media;
a second antenna means in a second enclosure located a distance from said first enclosure for receiving said RF radiation launched from said first antenna means after said RF radiation has traversed said turbulent media, and focusing said RF radiation onto detection means for determining a unique cryptographic key.
